(19) United States
(12) Patent Application Publication
(10) Pub. No.: US 2008/0155486 A1
(43) Pub. Date: Jun. 26, 2008

(54) SYSTEMS AND METHODS FOR REDUCING WIRING VIAS DURING SYNTHESIS OF ELECTRONIC DESIGNS

(75) Inventor: Louise H. Trevillyan, Katonah, NY (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, ARMONK, NY (US)

(21) Appl. No.: 11/613,754

(22) Filed: Dec. 20, 2006

(51) Int. Cl. G06F 17/50

(52) U.S. Cl. 716/9; 716/13

(57) ABSTRACT

Systems and methods for reducing wire vias during synthesis of electronic designs. Exemplary embodiments include an electronic design via reduction method, including marking a plurality of nets, each net having at least two pin connections as unprocessed, determining whether there are further unprocessed nets, selecting one of the plurality of nets and marking the net as processed, sorting pairs of pins on the net by a displacement, selecting an unprocessed pin pair having the smallest displacement relative to other of the plurality of unprocessed pin pairs, selectively removing a via between the pins, determining whether there are any further unprocessed pin pairs and determining whether there are any further unprocessed nets.

### TRADEMARK

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

The invention relates to electronic design synthesis, and particularly to systems and methods for reducing wire vias during synthesis of electronic designs.

2. Description of Background

Excess vias are undesirable from both a timing and yield point of view. Solutions to the problem of via reduction are normally given in the routing domain, such that the wires are routed in the design so as to have the fewest vias. This solution does not address the possibility of moving the pins so as to reduce the essential number of vias required for routing. In the classical method for wiring a chip or macro design, the wiring planes on the physical image are assigned directionality of vertical or horizontal, and the wires are routed rectilinearly, so that horizontal segments are routed on horizontal wiring planes (or layers) and vertical segments are routed on vertical wiring planes (or layers). In order to go from one wiring layer to another, it is necessary to insert a via. FIG. 1 illustrates this concept. Pin P1 is located at image coordinates (100, 20). A wire must be routed to Pin P2 that is located at image coordinates (200, 50). The horizontal wire segment from (100, 20) to (200, 20) is embedded on a horizontal layer. The vertical segment from (200, 20) to (200, 50) is embedded on a vertical layer. There is a via at (200, 20) to translate between these layers.

Vias are also used for purposes of pin access. The physical design of the standard cell may have the pins on a given layer, but the route comes in on a different layer. A via is then needed to connect the layers. Pin-access vias under some circumstances can be removed in the routing environment through use of layer assignment and wrong-way wires, but changes to placement cannot substantially affect the number of this type of via needed in the design. There are some exceptions to the directionality rule that allow vias to be avoided on some nets. Some wires, called “wrong-way wires”, may go in the opposite direction (horizontal on a vertical layer or vertical on a horizontal layer). This may be done, for example, to improve delay on a timing-critical net by avoiding a via on the wire. The disadvantage of wrong-way wires is that they block all “right way” wires from passing over them, so they create wiring blockages. For this reason, wrong-way wires are normally used only for short (5 track or fewer) jobs in the route. In FIG. 2, the vertical segment from (200, 20) to (200, 50) is implemented as a wrong-way wire. Then the wire from pin P3 to pin P4, which could have been a straight horizontal wire, must be routed around the wrong-way segment. One such route is shown in the example. This configuration saves delay on the P1->P2 wire, but adds delay, wire length and vias on the P3-P4 wire. Whenever the direction of a route changes, therefore, either it is necessary to insert a via or to use a wrong-way wire. In physical synthesis, the design is first placed on the image. This placement has the effects of assigning location to the pins of the standard-cell or gate-array component of the design (hereafter called a “box” or “cell”). When the design is routed, wires are run among the pins according to the connectivity of the design.

Prior to routing, but after placement, wires are modeled as Steiner trees. These trees are rectilinear representations of the net. There are many styles of Steiner trees, but typically these trees are minimum-wire-length rectilinear representations of the wires. Such Steiner trees, in general, may differ from actual routes because they are not affected by the availability of routing resources, so there may be more Steiner tree segments going over an area of the image that can actually be physically realized. Typically, the placement program attempts to minimize (rectilinear) wire length. However, there are many Steiner routes with equivalent lengths but differing number of segments. The route in FIG. 1 could represent a Steiner route. Steiner routes for a given net are not unique. For example, an alternate Steiner route for the net in FIG. 1 is a vertical segment from (100, 20) to (100, 50) and a horizontal route from (100, 50) to (200, 50). Both of these routes have the same length. Even for the simple cash shown in FIG. 1, it is possible for a Steiner route to have more than two segments. For example, another 4-segment route would be a horizontal segment form (100,20) to (150,20), a vertical segment from (150,20) to (150,40), a horizontal segment from (150,40) to (200, 40) and a vertical segment from (200,40) to (200,50). This 4-segment route has the same length as the two segment route shown in FIG. 1. The wire in FIG. 2 from P3->P4 does not represent a Steiner route because it is not the minimum distance. The minimum distance would be the straight horizontal line between the pins. This would be the Steiner route for this net, and there are no alternative Steiner routes. Another property of Steiner routes is that they represent the minimum via configuration for the wires (ignoring pin access vias). That is, if there are N changes in directionality to the Steiner, there must be at least N vias in the physical route. The physical route may have more vias due to blockages or congestion. For example, the P3->P4 net in FIG. 2 has 2 vias while the Steiner route has none. Vias that are required due to the Steiner routes are essential vias.

Typically, the minimum number of required vias is strictly a function of the placement. The router may add more, but cannot use fewer, vias than are dictated by the placement. FIG. 3 illustrates this concept. If the placement program chooses to place the box with pin P2 so that P2 is at location (200, 20) rather than (200, 50), as shown in FIG. 2, the vertical segment of the net from (200, 20) to (200, 50) is not necessary, which would eliminate a via. If, as shown in FIG. 3, that segment had been implemented as a wrong-way wire, the blockage for the P3->P4 net is eliminated, so the route is a straight horizontal route and the entire configuration is reduced by 2 vias.

It is desirable to reduce the number of vias in a design as much as possible, as they are relatively large, are poor for yield and are poor for wire delay. In addition, as technologies progress from 90 nm to 65 nm and beyond, vias become proportionately more expensive.

### SUMMARY OF THE INVENTION

Exemplary embodiments include an electronic design via reduction method, including marking a plurality of nets, each net having at least two pin connections as unprocessed, determining whether there are further unprocessed nets, selecting one of the plurality of nets and marking the net as processed, sorting pairs of pins on the net by a displacement, selecting an unprocessed pin pair having the smallest displacement relative to other of the plurality of unprocessed pin pairs, selectively removing a via between the pins, determining whether there are any further unprocessed pin pairs and determining whether there are any further unprocessed nets.

Further embodiments include a computer readable medium having computer executable instructions for performing an electronic design via reduction method, including marking a plurality of nets, each net having at least two pin connections as unprocessed, determining whether there are further unprocessed nets, selecting one of the plurality of nets and marking the net as processed, sorting pairs of pins on the net by a displacement, determining that there are not further unprocessed pin pairs, selecting an unprocessed pin pair having the smallest displacement relative to other of the plurality of unprocessed pin pairs, defining a identification procedure to determine whether the pin pairs are in at least one of fixed and in the same circuit row, recursively using said identification procedure until nor further pin pairs are identified as at least one of fixed and in the same circuit row, computing a displacement N between the pins of the pair, defining a displacement procedure to determine if N has exceeded a predetermined threshold, recursively using said displacement procedure while N has not exceeded the predetermined threshold, defining a constraints procedure that includes defining a move interval, recursively applying the constraints procedure to determine a location for the leftmost box and shifting the leftmost box along the move interval until it aligns with the rightmost box, recursively applying the constraints procedure to determine a location for the rightmost box and shifting the rightmost box along the move interval until it aligns with the leftmost box, determining whether the leftmost and rightmost boxes are positioned in locations within bounds of pre-determined constraints, and determining that there are not further unprocessed nets.

Additional embodiments include a method for reducing vias during synthesis of electronic designs, the method including selecting a plurality of nets, each net having at least two pin connections, counting a total number of vias for boxes to which all the pins on the nets are attached, determining a slack and violation ratio on each of the plurality of nets, ranking pairs of pins on each net by an offset of a horizontal position of the pins, recursively selecting pins in an order of increasing offset, wherein the offset determines a window in which boxes may be positioned, selectively sliding rightmost and leftmost boxes to determine an alignment of the boxes within pre-determined constraints, selecting the window such that it is within a pre-determined displacement, and determining that the pins are in alignment within the predetermined constraints.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically, the reduction of the number of wiring vias required to route a chip design has been achieved. In addition, a method for altering the physical placement of library cells in a design so as to reduce vias and improve wirability is provided. Methods include moving the cells so that the pins align and no intermediate via is required. The method improves wirability in two ways: (1) via reduction by itself frees up wiring resources for the router to use, and (2) the elimination of wrong-way wires reduces wiring blockages.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a prior art segment route;

FIG. 2 illustrates a prior art segment route;

FIG. 3 illustrates a prior art segment route;

FIG. 4 illustrates a segment route in accordance with exemplary embodiments;

FIG. 5 illustrates a segment route in accordance with exemplary embodiments;

FIG. 6A illustrates a partial flowchart of an exemplary via reduction method;

FIG. 6B illustrates a partial flowchart of an exemplary via reduction method;

FIG. 6C illustrates a partial flowchart of an exemplary via reduction method; and

FIG. 6D illustrates a partial flowchart of an exemplary via reduction method.

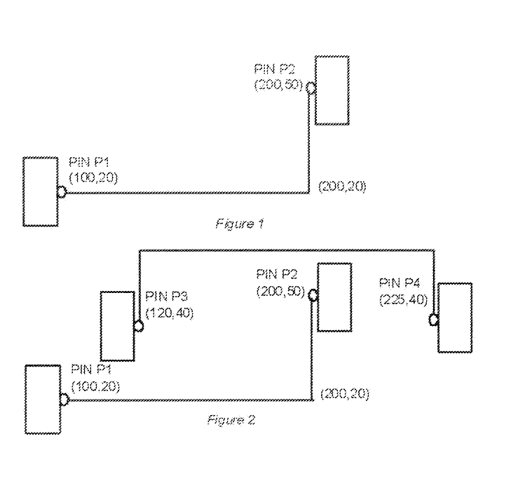

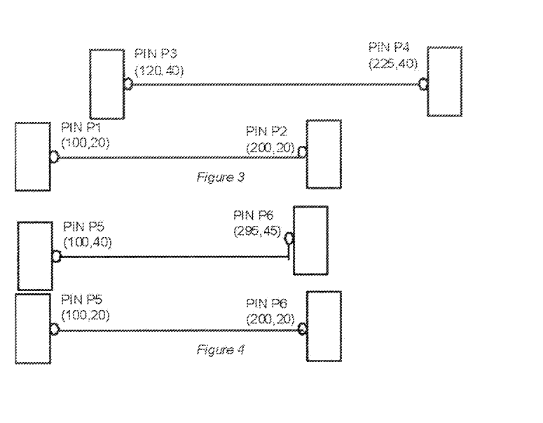

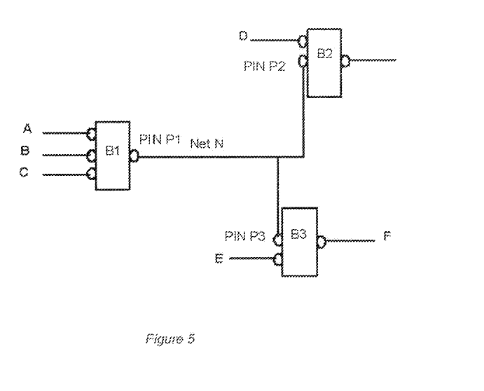

The detailed description explains the preferred embodiments of the invention, together with advantages and features, by way of example with reference to the drawings.

### DETAILED DESCRIPTION OF THE INVENTION

For illustrative purposes of the discussion herein, pin-access vias are treated as fixed. The vast majority of vias in a design are pin-access vias. In a 3-million-box design, there can be in excess of 12 million pin-access vias. Because they are not in general reducible, the percentage of total vias that can be saved by routing and placement changes is necessarily small.

The minimum number of vias required to route any net is determined by the placement of the pins to which the net is connected. It is possible that a router requires more vias, due to blockages and/or congestion, but it cannot route a net using fewer vias than there are “bends” in a minimum-via Steiner route. By altering the placement of cells in the design to produce pin alignment and removing the bends in the Steiner route, it is possible to reduce the number of “essential” vias, thus improving routability as well as reducing the need for vias.

FIG. 4 illustrates a via pattern resulting from the method discussed further in the description below. Connected boxes are moved small distances to align pins and remove essential vias. To some extent, especially in non-timing-critical regions of the design, the exact placement of a box in the image is arbitrary. Moving a box a few tracks makes no important difference to the timing or electrical properties of the design. This point is further shown in FIG. 4, where moving pin P8 down 5 vertical tracks and over 5 horizontal tracks exactly preserves the Steiner wire length but eliminates one essential via. This placement can be done as long as there is room for the moved box and timing and electrical properties are still correct. In general, small box movements can be done to align pins in order to remove vias.

There are a number of constraints on the movement of any box, which include: a move 1) must not make a critical slack worse; 2) cause an electrical violation; 3) cause a placement overlap; 4) cause a box to be placed illegally; 5) increase the number of vias in the pattern; and 6) cause large increases in the wire length of the design. It is possible that moving a box to straighten one wire may cause bends on the Steiner trees of other nets connected to the box, so that a move can actually add vias or not save any of them.

Placements are done in terms of either horizontal or vertical circuit rows. Getting pin alignment is generally possible in one direction because of the way the cells are designed to connect to power and ground. If the circuit rows are horizontal, only vertical alignment is explored; if the rows are vertical, horizontal alignment is most productive. Without loss of generality, this document will consider only horizontal circuit rows.

The method starts by choosing a net with at least two pin connections. For the boxes to which the all the pins on the nets are attached, count the total number of vias on all nets attached to all pins on the box. Note the worst slack and worst violation ratio on each of these nets. Rank the pair of pins on the net by the offset of the horizontal positions of the pins. Visit the pairs of pins in the order of increasing offset.

The offset forms a window in which the boxes may slide. For an offset of N, if the leftmost box slides toward the right by K positions, then the rightmost box must slide left N-K positions. It may be that one of the other of the boxes cannot move. If this is the case, then there is at most one legal alignment placement consisting of moving the other box all N tracks.

In general, a search window is determined which defines the range of tracks the leftmost boxes moves. The window could be greater than or equal to N. Begin searching by trying to move the leftmost box to the first position in the search range. If it meets constraints 1-4, try to move the rightmost box toward the left so that the pins are aligned. If it meets constraints 1-4, there is an alignment. Check constraints 5 and 6. If the configuration passes, the pins have been successfully aligned. If the pins cannot be aligned, continue moving the rightmost box to the left and the leftmost box to the right within the search range until either there is a successful alignment or the search range has been exhausted. If a move is accepted, “fix” the two moved boxes in place so they cannot move. Then continue looking at the rest of the pairs of pins on the net.

In FIG. 5, the configuration illustrates that the method collects all via counts and slack information on nets A, B, C, D, E, F and N. It then attempts to align P2 and P3, by moving box B3 to the right and/or B2 to the left. If it can find a legal aligned placement that does not cause timing or electrical degradation, it rechecks the number of vias on all of the nets. If the number of vias is strictly less than the original count, the move can be accepted. If P2 and P3 cannot be aligned successfully, the method would then try to aligned P1 and P3, and then P1 and P2. If P2 and P3 can be aligned successfully, then the method would attempt to align P1 with P2 and P3, without further moving P2 and P3.

The table below shows how many essential vias are removed from Steiner routes for 2-pin nets on a variety of designs.

| | | # 2-pin | # bends | |
|---|---|---|---|---|
| Design | tech | nets | removed | % Reduction |
| design 1 | sa27e | 39719 | 6103 | 16.8 |
| design 2 | sa27e | 86712 | 3769 | 4.9 |
| design 3 | sa27e | 190572 | 8344 | 5.2 |
| design 4 | sa12e | 48209 | 7003 | 15.9 |
| design 5 | cu11 | 30053 | 2307 | 8.3 |
| design 6 | cu11 | 37980 | 2130 | 6.1 |
| design 7 | cu11 | 21809 | 1703 | 8.7 |
| design 8 | cu65 | 70321 | 2599 | 4.6 |
| design 9 | | 525375 | 34458 | 8.8 |

The above table indicates the number of Steiner bends that are removed from the design. In general, the method works to optimize how well the router can take advantage of the reduced Steiner bends in reducing vias or wrong-way wires in actual routes. In one example, a larger design of 650,000 boxes is routed with a standard wiring program. The total number of vias is reduced by 1%, the number of wrong-way wires is smaller, and the completion rate increased, so that 43,800 additional nets are successfully routed in the design where pin alignment is done than in the baseline without pin alignment.

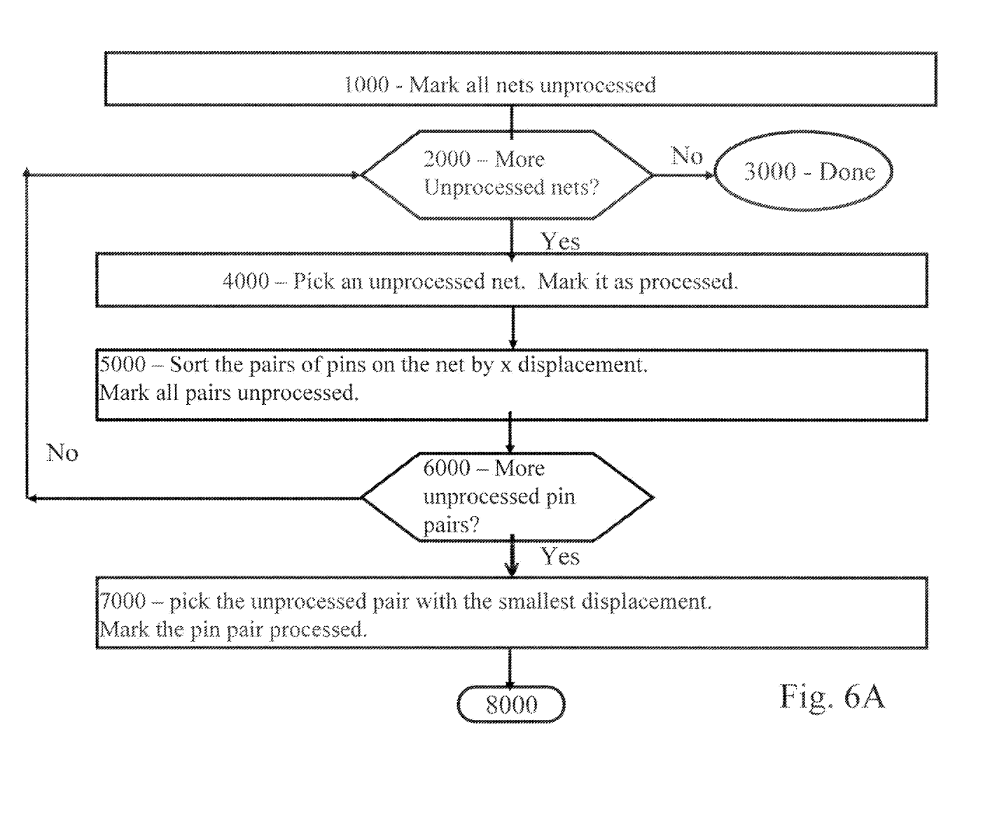

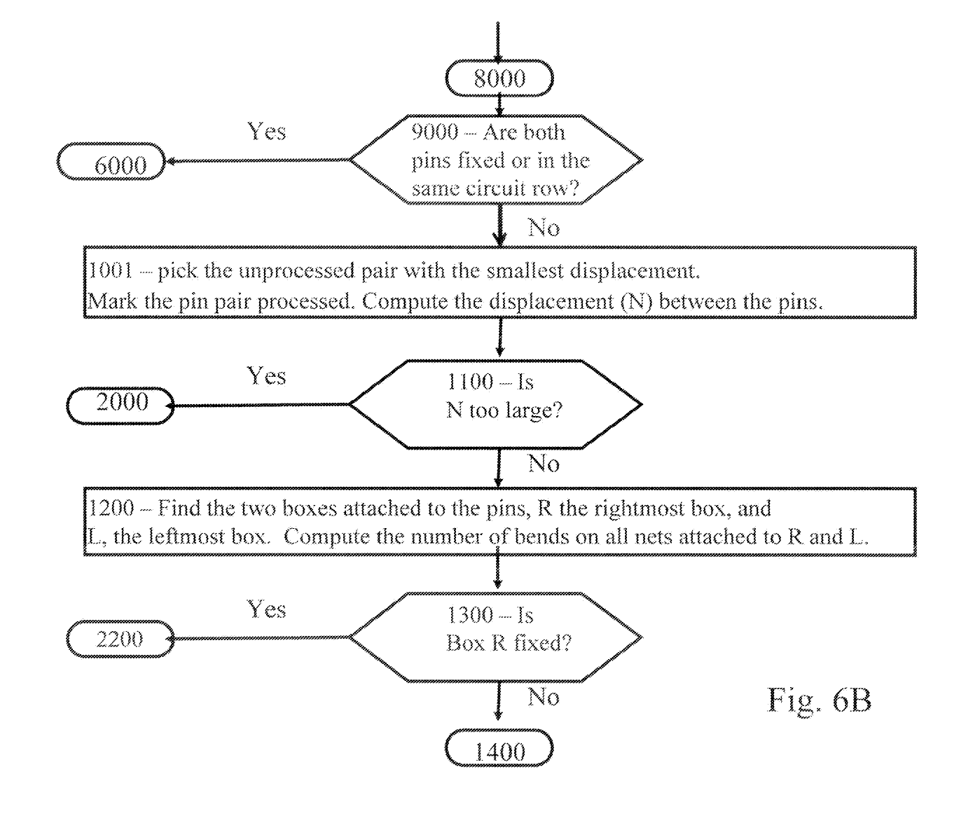

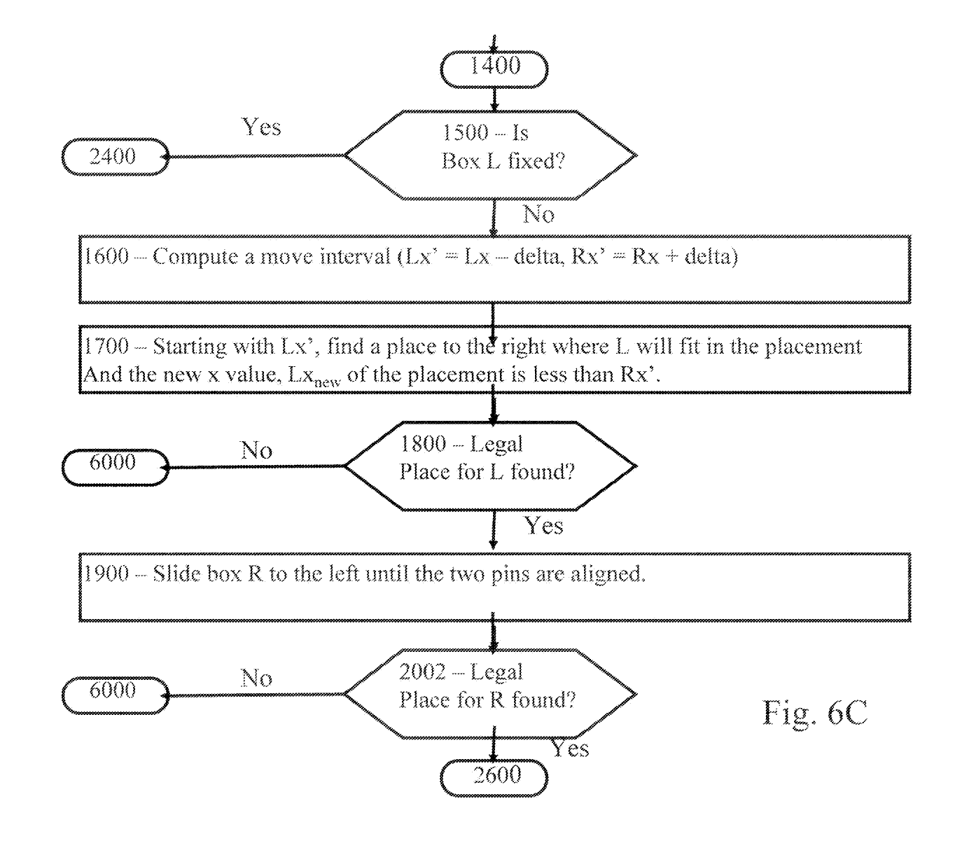

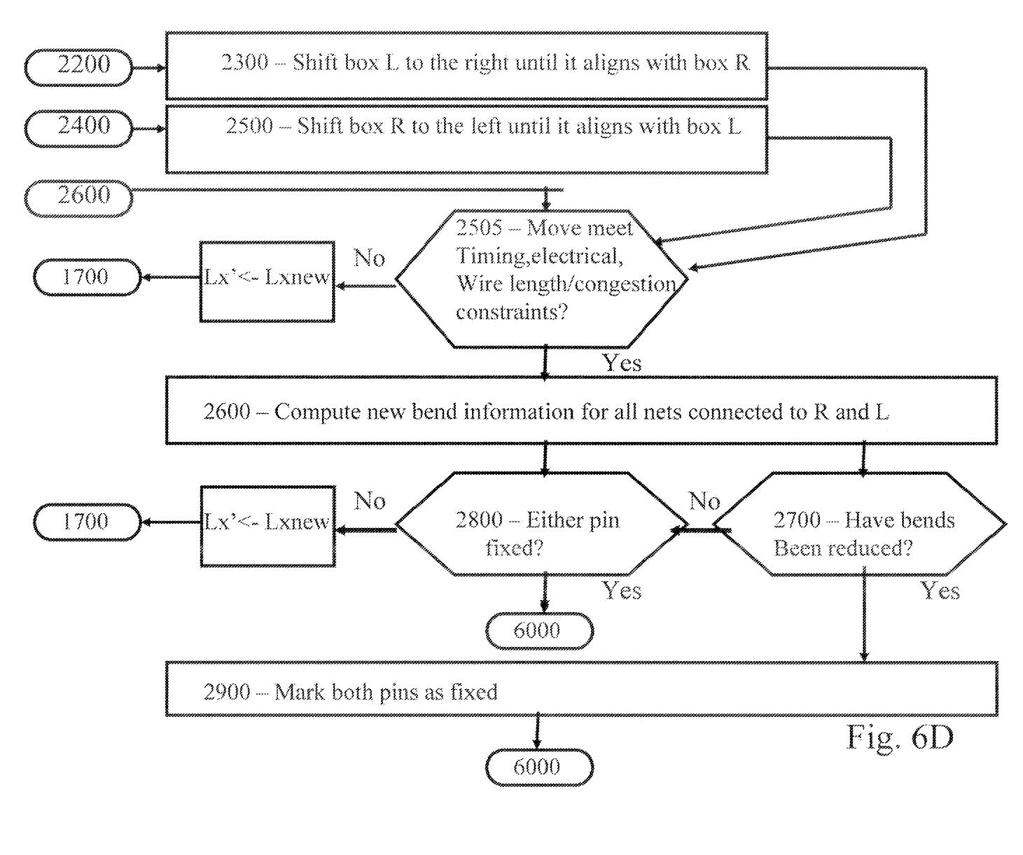

FIGS. 6A-6D illustrate an exemplary via reduction method. At step 100, all nets are marked as unprocessed. At step 2000, it is determined whether or not there are more unprocessed nets. If there are no further unprocessed nets, then the method is complete at step 3000. If there are further unprocessed set, then at step 4000, an unprocessed net is selected and marked as processed. At steps 5000, pairs of pins are sorted on the net by x displacement. All pairs are marked as unprocessed. At step 6000, it is determined whether or not there are further unprocessed pairs. If there are no further unprocessed pin pairs then step 2000 is repeated. If there are further unprocessed pin pairs, then at step 7000, an unprocessed pair with the smallest displacement is selected and the pin pair is marked as processed. At step 9000 it is determined whether or not both pins are fixed or in the same circuit row. If the pins are fixed or in the same circuit row then step 6000 is repeated. If the pins are not fixed or in the same circuit row, then at step 1001, the unprocessed pair with the smallest displacement is selected. The pair is marked as processed and the displacement N between the pins is computed. At step 1100, it is determined whether N is too large. The variable MAX_MOVE is a parameter to the program and represents the largest amount the program is allowed to move a box. In the flowchart, N is too large if it is greater than MAX_MOVE. MAX_MOVE is normally determined based on the design size and the technology. If a box is moved MAX_MOVE tracks, some nets could get at least MAX_MOVE longer. If MAX_MOVE is too large, the extra wire delay could cause a degradation in the timing of the design. The setting of MAX_MOVE also governs the run time of the program. The larger MAX_MOVE is, the slower the program will run. If N is too large, then step 2000 is repeated. If N is not too large, then at step 1200, two boxes attached to the pins are located, generally the rightmost and leftmost boxes. The number of bends on all nets attached to the rightmost and leftmost boxes is computed. At step 1300, it is determined whether or not the Right Box is fixed. If it is fixed, then at step 2300, the Left Box is shifted to the right until it aligns with the Right Box. If the Right Box is not fixed, then at step 2500, the Right Box is shifted to the left until it aligns with the Left Box. It is appreciated that steps 2300, 2500 proceed to step 2505, which is discussed further below.

If neither the Right Box nor the Left Box is fixed, then at step 1600, a move interval (defined as Lx′=Lx−Δ, and Rx′=Rx+Δ) is computed. At step 1700, starting with Lx′, a place to the right where L fits in the placement is determined. A new x value, Lxnew of the placement is less than Rx. At step 1800 it is determined whether or legal (e.g., permissible within fabrication standards) place for the leftmost box has been found. If a legal place for the leftmost box has not bee found, then step 6000 is repeated. If a legal place for the leftmost box has been determined, then at step 1900, the Right Box is slid to the left until the two pins are aligned. At step 2002, it is determined whether or not a legal place for R has been found. If no legal place has been found, then step 6000 is repeated. If a legal place has been found then the method moves to step 2505.

As discussed above, the method proceeds to step 2505 after steps 2300, 2500. It is now appreciated that the method also proceeds to step 2500 after step 2002. At step 2505, the above-discussed restraints are considered. If the constraints have not been met, then at then assign Lxnew to Lx′ and step 1700 is repeated. If the constraints are met, then at step 2600 new bend information for all nets connected to the rightmost and leftmost boxes are computed. In addition, at step 2700, it is determined whether or not the bends have been reduced. If the bends have been reduced, then at step 2900, both pins are marked as fixed and step 6000 is repeated. If the bends have not been reduced, then the method proceeds to step 2800. At step 2800, it is determined whether either pin is fixed. If either of the pins are not fixed, then assign Lxnew to L′ and step 1700 is repeated. If either of the pins is fixed, then step 6000 is repeated. It is appreciated that the above-described method can be implemented in the design of electronic circuits to determine efficient placement of vias.

It is appreciated that alignment done with Steiner routes has been discussed. However, in alternate embodiments, methods can be generalized to any kind of route, including global, track (conduit) or detailed routes, by way of example.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. An electronic design via reduction method, comprising:
marking a plurality of nets, each net having at least two pin connection as unprocessed;
determining whether there are further unprocessed nets;
selecting one of the plurality of nets and marking the net as processed;
sorting pairs of pins on the net by a displacement;
selecting an unprocessed pin pair having the smallest displacement relative to other of the plurality of unprocessed pin pairs;
selectively removing a via between the pins;
determining whether there are any further unprocessed pin pairs; and
determining whether there are any further unprocessed nets.

2. The method as claimed in claim 1 further comprising determining whether each of the pins in the pin pair is at least one of fixed and in a same circuit row

3. The method as claimed in claim 2 wherein selecting an unprocessed pair with the smallest displacement occurs if the pin pair is not at least one of fixed and in the same circuit row.

4. The method as claimed in claim 3 further comprising computing a displacement N between the pins of the pin pair.

5. The method as claimed in claim 4 further comprising determining if N is below a predetermined displacement threshold.

6. The method as claimed in claim 5 further comprising:
selecting boxes attached to the pins; and
determining a leftmost box and a rightmost box.

7. The method as claimed in claim 6 further comprising in response to the leftmost box and rightmost box being unfixed, computing a move interval.

8. The method as claimed in claim 7 further comprising selecting a displacement relative to the move interval such that a displacement of the leftmost box and the rightmost box fall within a set of constraints.

9. The method as claimed in claim 8 wherein the set of constraints are selected from the group consisting of: a move must not make a critical slack worse; a move must not cause an electrical violation; a move must not cause a placement overlap; a move must not cause a box to be placed illegally; a move must not increase the number of vias in the pattern; and a move must not cause large increases in the wire length of the design.

10. The method as claimed in claim 9 further comprising in response to at least the placement of the leftmost and rightmost boxes being displaced within constraints, computing new bend information for all nets connected to the leftmost and rightmost boxes.

11. The method as claimed in claim 10 further comprising marking both of the pins in the pin pair as fixed if the bends have been reduced.

12. A computer readable medium having computer executable instructions for performing an electronic design via reduction method, comprising:
marking a plurality of nets, each net having at least two pin connections as unprocessed;
determining whether there are further unprocessed nets;
selecting one of the plurality of nets and marking the net as processed;
sorting pairs of pins on the net by a displacement;
determining that there are no further unprocessed pin pairs;
selecting an unprocessed pin pair having the smallest displacement relative to other of the plurality of unprocessed pin pairs.
defining a identification procedure to determine whether the pin pairs are in at least one of fixed and in the same circuit row;
recursively using said identification procedure until no further pin pairs are identifies as at least one of fixed and in the same circuit row;
computing a displacement N between the pins of the pin pair;
defining a displacement procedure to determine if N has exceeded a predetermined threshold;
recursively using said displacement procedure while N has not exceeded the predetermined threshold;
defining a constraints procedure that includes:
defining a move interval;
recursively applying the constrains procedure to determine a location for the leftmost box and shifting the leftmost box along the move interval until it aligns with the rightmost box;
recursively applying the constraints procedure to determine a location for the rightmost box and shifting the rightmost box along the move interval until it aligns with the leftmost box;
determining whether the leftmost and rightmost boxes are positioned in locations within bounds of pre-determined constraints; and
determining if there are any further unprocessed nets.

13. A method for reducing vias during synthesis of electronic designs, the method comprising:
selecting a plurality of nets, each net having at least two pin connections;
counting a total number of vias for boxes to which all the pins on the nets are attached;
determining a slack and violation ration on each of the plurality of nets;
ranking pairs of pins on each net by an offset of a horizontal position of the pins;
recursively selecting pins in an order of increasing offset, wherein the offset determines a window in which boxes may be positioned;
selectively sliding rightmost and leftmost boxes to determine an alignment of the boxes within pre-determined constraints;
selecting the window such that it is within a predetermined displacement; and
determining that the pins are in alignment within the predetermined constraints.

14. The method as claimed in claim 13 wherein the predetermined constraints are selected from the group consisting of: a move must not make a critical slack worse; a move must not cause an electrical violation; a move must not cause a placement overlap; a move must not cause a box to be placed illegally; a move must not increase the number of vias in the pattern; and a move must not cause large increases in the wire length of the design.

15. The method as claimed in claim 14 further comprising determining that the search window has been exhausted.

16. The method as claimed in claim 15 further comprising: determining if either of the pins of the pin pair is fixed, and determining whether or not bends on the net have been reduced in response to neither of the pins being fixed.

17. The method as claimed in claim 16 further comprising determining that there are no remaining unprocessed pin pairs.

18. The method as claimed in claim 17 wherein the unprocessed pin pair with a displacement smallest relative to remaining pin pair is selected.

19. The method as claimed in claim 18 further comprising fixing the rightmost and leftmost boxes.

20. The method as claimed in claim 19 further comprising determining that there are any remaining unprocessed nets.
